(19) United States
(12) Patent Application Publication
(10) Pub. No.: US 2011/0122733 A1
(43) Pub. Date: May 26, 2011

(54) Stepping motor control circuit and analog electronic timepiece

(76) Inventors: Keishi Honmura, Chiba-shi (JP); Akira Takakura, Chiba-shi (JP); Saburo Manaka, Chiba-shi (JP); Kazumi Sakumoto, Chiba-shi (JP); Kosuke Yamamoto, Chiba-shi (JP); Takanori Hasegawa, Chiba-shi (JP); Kenji Ogasawara, Chiba-shi (JP); Hiroshi Shimizu, Chiba-shi (JP); Tomohiro Ihashi, Chiba-shi (JP); Kazuo Kato, Chiba-shi (JP); Erico Noguchi, Chiba-shi (JP)

(21) Appl. No.: 12/924,552

(22) Filed: Sep. 29, 2010

(30) Foreign Application Priority Data
Sep. 30, 2009 (JP) 2009-228964

(51) Int. Cl. G04B 19/04; H02P 8/38

(52) U.S. Cl. 368/80; 318/696

(57) ABSTRACT

A stepping motor control circuit includes a rotation detection portion that detects a rotation condition of a stepping motor, and a control portion that drives and controls the stepping motor by a correction drive pulse P2 having larger drive energy than one of any one of a plurality of main drive pulses P1 each having different drive energy and the respective main drive pulses P1 depending on a detection result of the rotation detection portion. The control portion drives the stepping motor by switching to a fixed drive pulse having drive energy not smaller than drive energy of a main drive pulse P1nmax having maximum drive energy in a case where there is no drive allowance when the stepping motor is driven by the main drive pulse P1nmax having the maximum drive energy. The stepping motor is thus rotary driven normally even in a DC magnetic field.

### BACKGROUND OF THE INVENTION

1. Field of the Invention

The present invention relates to a stepping motor control circuit and an analog electronic timepiece using the stepping motor control circuit.

2. Background Art

A bipolar PM (Permanent Magnet) stepping motor is used in an electronic device, such as an analog electronic timepiece. The bipolar PM stepping motor includes a stator having a rotor accommodation hole and a positioning portion that determines a rotor stop position, a rotor provided in the rotor accommodation hole, and a coil, and it is configured to rotate the rotor and to stop the rotor at a position corresponding to the positioning portion by supplying an alternating signal to the coil for the stator to generate a magnetic flux.

As a low-consumption drive method of the bipolar PM stepping motor, a correction drive method of a stepping motor provided with a plurality of types of main drive pulses P1 responsible for driving during normal times and a correction drive pulse P2 having larger drive energy than the respective main drive pulses and responsible for driving at a time of load fluctuation is in practical use. It is configured in such a manner that a plurality of types of drive pulses each having different drive energy are prepared in advance as the main drive pulses P1 and the main drive pulses P1 decrease and increase energy depending on whether the rotor is rotating or not to shift a rank of drive energy, so that the stepping motor is driven by the smallest possible energy as is described, for example, in JP-B-61-15385.

This correction drive method is configured as follows. That is, (1) a main drive pulse P1 is outputted to one of the poles of the drive coil, O1, of the stepping motor to detect an induced voltage generated in the coil by rotor oscillations that occur immediately after the output. (2) In a case where the induced voltage exceeds an arbitrarily-set reference threshold voltage, the main drive pulse P1 maintaining the energy is outputted to the other pole of the drive coil, O2. This processing is repeated a certain number of times as long as the rotor is rotating. When the number of repetition times reaches a certain number of times (PCD), a main drive pulse P1 having drive energy downgraded by one rank (rank down) is outputted to the other pole and this processing is repeated again. (3) In a case where the induced voltage does not exceed the reference threshold voltage, it is determined that the rotor is not rotating. A correction drive pulse P2 having large drive energy is thus immediately outputted to the same pole to forcedly rotate the rotor. During the next driving, (1) through (3) are repeated by outputting, to the other pole, a main drive pulse P1 having energy upgraded by one rank (rank up) than that of the main drive pulse P1 by which the rotor fails to rotate.

Also, according to the invention described in WO 2005/119377, means for determining a detection time of an induced signal by a comparison with a reference time when detecting rotations of the stepping motor is provided in addition to a detection of an induced signal level. After the stepping motor is rotary driven by a main drive pulse P11, a correction drive pulse P2 is outputted when the induced signal drops below a predetermined reference threshold voltage Vcomp. A following main drive pulse P1 is changed (rank up) to a main drive pulse P12 having larger energy than the main drive pulse P11 to drive the stepping motor. When a detection time with the rotations by the main drive pulse P12 is earlier than the reference time, the main drive pulse P12 is changed (rank down) to the main drive pulse P11. Power consumption is thus reduced by rotating the stepping motor by the main drive pulses P1 corresponding to the load during the driving.

In addition, there is an electronic timepiece in the related art configured in such a manner that the stepping motor is driven by setting a drive pulse to a fixed drive pulse having predetermined drive energy upon detection of an external AC magnetic field, so that the stepping motor is rotated stably without an erroneous detection of rotation. This configuration, however, does not address an external DC magnetic field. Hence, there arises a problem that the stepping motor has a malrotation in the presence of an external DC magnetic field, which causes an abnormal hand movement operation of the pointer.

### SUMMARY OF THE INVENTION

It is an aspect of the present invention to rotary drive a stepping motor normally even in a DC magnetic field without an erroneous detection of rotation while suppressing power consumption.

A stepping motor control circuit according to another aspect of the invention includes: a rotation detection portion that detects a rotation condition of a stepping motor; and a control portion that drives and controls the stepping motor by a drive pulse having larger drive energy than one of any one of a plurality of main drive pulses each having different drive energy and the respective main drive pulses depending on a detection result of the rotation detection portion. The control portion drives the stepping motor by switching to a fixed drive pulse having drive energy not smaller than drive energy of a main drive pulse having maximum drive energy in a case where there is no drive allowance when the stepping motor is driven by the main drive pulse having the maximum drive energy.

An analog electronic timepiece according to another aspect of the invention includes a stepping motor that rotary drives an hour hand and a stepping motor control circuit that controls the stepping motor. The stepping motor control circuit described above is used as the stepping motor control circuit of the analog electronic timepiece.

According to the stepping motor control circuit of the invention, it becomes possible to rotary drive the stepping motor normally even in a DC magnetic field while reducing power consumption.

Also, according to the analog electronic timepiece of the invention, a precise hand movement operation can be achieved because it becomes possible to rotary drive the stepping motor normally even in a DC magnetic field while reducing power consumption.

### BRIEF DESCRIPTION OF THE DRAWINGS

FIG. 1 is a block diagram of a stepping motor control circuit and an analog electronic timepiece according to one embodiment of the invention;

FIG. 2 is a view showing the configuration of a stepping motor used in an analog electronic timepiece according to one embodiment of the invention;

FIG. 3 is a timing chart used to describe operations of a stepping motor control circuit and an analog electronic timepiece according to one embodiment of the invention;

FIG. 4 is a timing chart used to describe operations of a stepping motor control circuit and an analog electronic timepiece according to another embodiment of the invention;

FIG. 5 is a flowchart depicting operations of a stepping motor control circuit and an analog electronic timepiece according to a first embodiment of the invention; and

FIG. 6 is a flowchart depicting operations of a stepping motor control circuit and an analog electronic timepiece according to a second embodiment of the invention.

### DESCRIPTION OF THE PREFERRED EMBODIMENTS

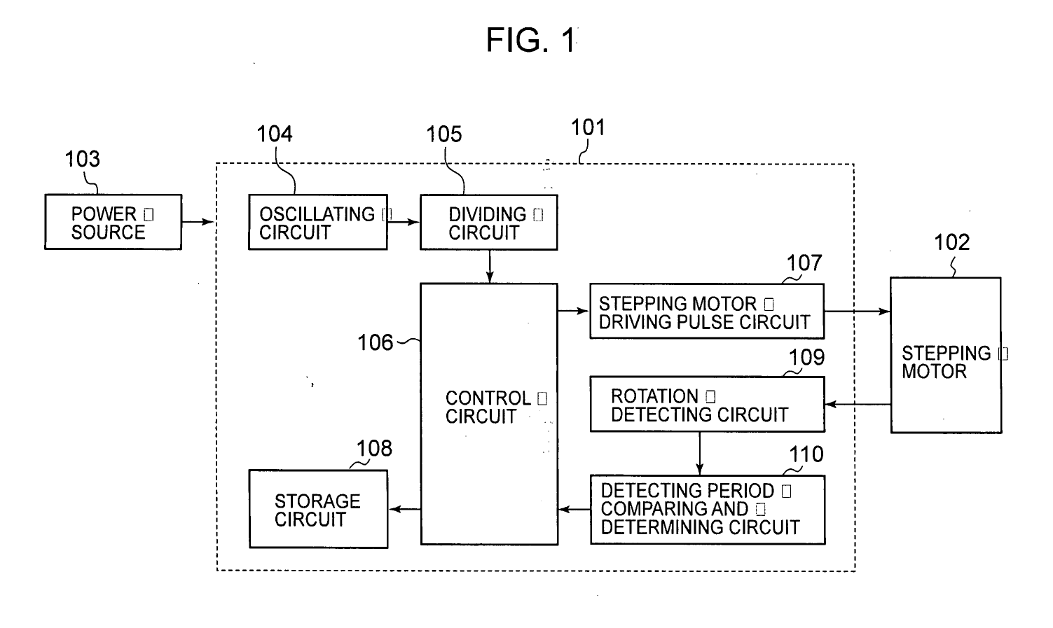

FIG. 1 is a block diagram of an analog electronic timepiece using a stepping motor control circuit according to one embodiment of the invention and it shows an analog electronic watch by way of example.

Referring to FIG. 1, the analog electronic timepiece includes a stepping motor control circuit 101, a stepping motor 102 that is rotated under the control of the stepping motor control circuit 101 and rotary drives the time hands and a calendar mechanism (not shown), and a power supply 103, such as a battery, that supplies drive power to circuit elements, such as the stepping motor control circuit 101 and the stepping motor 102.

The stepping motor control circuit 101 includes an oscillation circuit 104 that generates a signal at a predetermined frequency, a frequency dividing circuit 105 that frequency-divides a signal generated in the oscillation circuit 104 to generate a timepiece signal that serves as the timekeeping reference, a control circuit 106 that controls respective electronic circuit elements forming the electronic timepiece and controls a change of a drive pulse, a stepping motor drive pulse circuit 107 that selects a drive pulse for motor rotary drive according to a control signal from the control circuit 106 and outputs the selected drive pulse to the stepping motor 102, a rotation detection circuit 109 that detects an induced signal indicating a rotation condition from the stepping motor 102 in a predetermined detection period, a detection time comparison and determination circuit 110 that compares a time when the rotation detection circuit 109 detects an induced signal exceeding a predetermined reference threshold voltage with sections forming the detection period to detect in which section the induced signal is generated, and a storage circuit 108 that stores information on main drive pulses P1, a correction drive pulse P2, and a rotation detection.

The rotation detection circuit 109 is based on the same principle as that of the rotation detection circuit described in JP-B-61-15385. It detects whether an induced signal VRs generated by free oscillations immediately after the driving of the stepping motor 102 exceeds a predetermined reference threshold voltage Vcomp in a predetermined detection period and each time it detects an induced signal VRs exceeding the reference threshold voltage Vcomp, it notifies the detection time comparison and determination circuit 110 of the detection.

The detection time comparison and determination circuit 110 compares a time when the rotation detection circuit 109 detects an induced signal exceeding the predetermined reference threshold voltage with sections forming the detection period to determine in which section the induced signal is generated. As will be described below, the control circuit 106 controls switching of drive pulses (pulse control) according to a VRs pattern obtained as the result of determination by the detection time comparison and determination circuit 110.

The storage circuit 108 stores information on main drive pulses in a plurality of types of pulse ranks that are preliminarily provided to the stepping motor control circuit 101, a correction drive pulse, a fixed pulse, and a rotation detection.

Herein, the oscillation circuit 104 and the frequency dividing circuit 105 together form a signal generation portion. The storage circuit 108 forms a storage portion. The rotation detection circuit 109 and the detection time comparison and determination circuit 110 together form a rotation detection portion. Also, the oscillation circuit 104, the frequency dividing circuit 105, the control circuit 106, the stepping motor drive pulse circuit 107, and the storage circuit 108 together form a control portion.

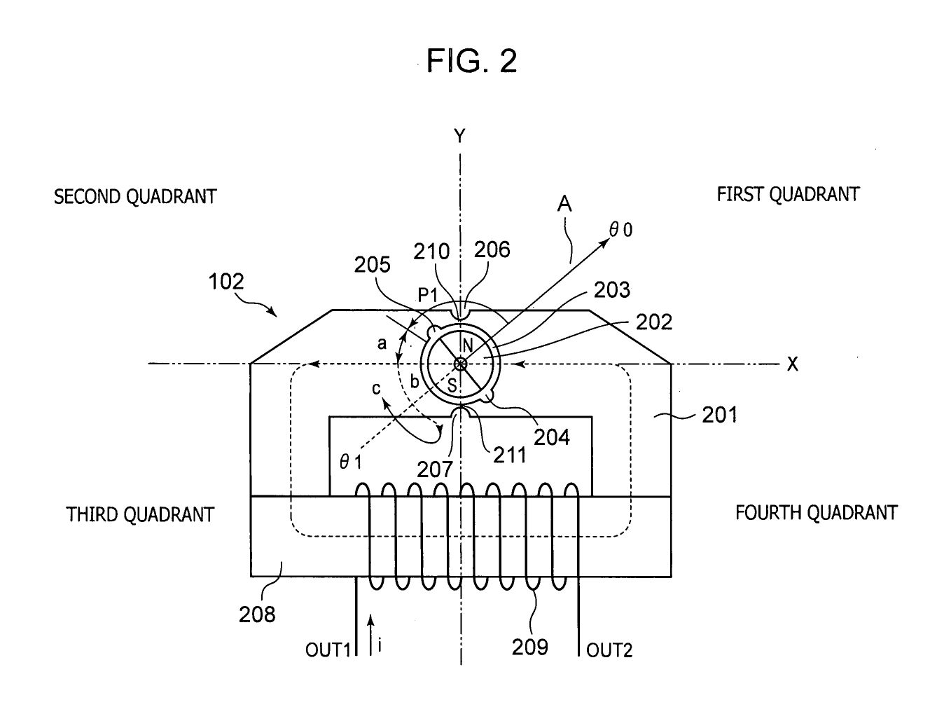

FIG. 2 is a view showing the configuration of the stepping motor 102 used in one embodiment of the invention and it shows a bipolar PM stepping motor typically used in an analog electronic timepiece by way of example.

Referring to FIG. 2, the stepping motor 102 includes a stator 201 having a rotor accommodation through-hole 203, a rotor 202 provided in the rotor accommodation through-hole 203 in a rotatable manner, a magnetic core 208 joined to the stator 201, and a drive coil 209 wound around the magnetic core 208. In a case where the stepping motor 102 is used in an analog electronic timepiece, the stator 201 and the magnetic core 208 are fixed to a bottom board (not shown) with screws (not shown) or caulking (not shown) and joined to each other. The drive coil 209 has a first terminal OUT1 and a second terminal OUT2.

The rotor 202 is magnetized to two poles (South pole and North pole). A plurality (two, herein) of notch portions (outer notches) 206 and 207 are provided to the outer end portion of the stator 201 made of a magnetic material at positions opposing each other with the rotor accommodation through-hole 203 in between. Saturable portions 210 and 211 are provided between the respective outer notices 206 and 207 and the rotor accommodation through-hole 203.

The saturable portions 210 and 211 are configured in such a manner that they are not magnetically saturated with a magnetic flux of the rotor 202 but magnetically saturated when the drive coil 209 is excited so that the magnetic resistance becomes larger. The rotor accommodation through-hole 203 is made in a circular hole shape formed integrally with a plurality (two, herein) of crescentic notch portions (inner notches) 204 and 205 in opposing portions of the through-hole having a circular outline.

The notch portions 204 and 205 form a positioning portion used to determine a stop position of the rotor 202. In a state where the drive coil 209 is not excited, the rotor 202 is stably at a stop at a position corresponding to the positioning portion as is shown in FIG. 2, in other words, at a position (position at an angle θ0) at which the axis of magnetic poles, A, of the rotor 202 intersects at right angles with a line linking the notch portions 204 and 205. The X-Y coordinate space about the rotation shaft of the rotor 202 is divided to four quadrants (first quadrant through fourth quadrant).

When a current i is flown in the direction indicated by an arrow of FIG. 2 by supplying a rectangular-wave drive pulse in a first polarity (for example, the first terminal OUT1 is the positive pole and the second terminal OUT2 is the negative pole) from the stepping motor drive pulse circuit 107 between the terminals OUT1 and OUT2 of the drive coil 209, a magnetic flux is generated in the stator 201 in the direction indicated by a broken arrow. Accordingly, the saturable portions 210 and 211 are saturated and the magnetic resistance becomes larger. Thereafter, the rotor 202 rotates by 180 degrees in the direction indicated by an arrow of FIG. 2 by an interaction of the magnetic pole generated in the stator 201 and the magnetic pole of the rotor 202 and the axis of magnetic poles, A, stably stops at a position at an angle θ1. It should be noted that a rotation direction to perform a normal operation (herein, a hand movement operation because a description is given to the analog electronic timepiece) by rotary driving the stepping motor 102 is defined as a positive direction (counterclockwise direction in FIG. 2) and a direction inverse to this direction (clockwise direction) is defined as an inverse direction.

Subsequently, when the current i is flown inversely to the direction indicated by the arrow of FIG. 2 by supplying a rectangular-wave drive pulse in a second polarity (the first terminal OUT1 is the negative pole and the second terminal OUT2 is the positive pole so that the polarity is inversed to the polarity of the driving described above) different from the first polarity from the stepping motor drive pulse circuit 107 between the terminals OUT1 and OUT2 of the drive coil 209, a magnetic flux is generated in the stator 201 in a direction inverse to the direction indicated by the broken arrow. Accordingly, the saturable portions 210 and 211 are saturated first and then the rotor 202 rotates by 180 degrees in the same direction described above (positive direction) by an interaction of the magnetic pole generated in the stator 201 and the magnetic pole of the rotor 202 and the axis of magnetic poles, A, stably stops at the position at the angle θ0.

It is configured in such a manner that by supplying thereafter a signal having different polarities (alternating signal) to the drive coil 209 in this manner, the operation described above is performed repetitively, so that the rotor 202 is rotated continuously by 180 degrees at a time in the direction indicated by the arrow.

Although it will be described below, a plurality of main drive pulses P11 through P1nmax each having different drive energy, a fixed drive pulse having drive energy not smaller than that of the main drive pulse P1nmax and causing no erroneous detection of rotation, and a correction drive pulse P2 having drive energy not smaller than that of the fixed drive pulse are used as drive pulses in this embodiment. Regarding the magnitude (pulse rank) of the drive energy of the main drive pulses P1, the drive energy of P11 is the minimum and that of P1nmax is the maximum. The correction drive pulse P2 is a drive pulse having drive energy capable of forcedly rotating the stepping motor 102 even when a load increases due to load fluctuation. In addition, the correction drive pulse P2 is used also as the fixed drive pulse.

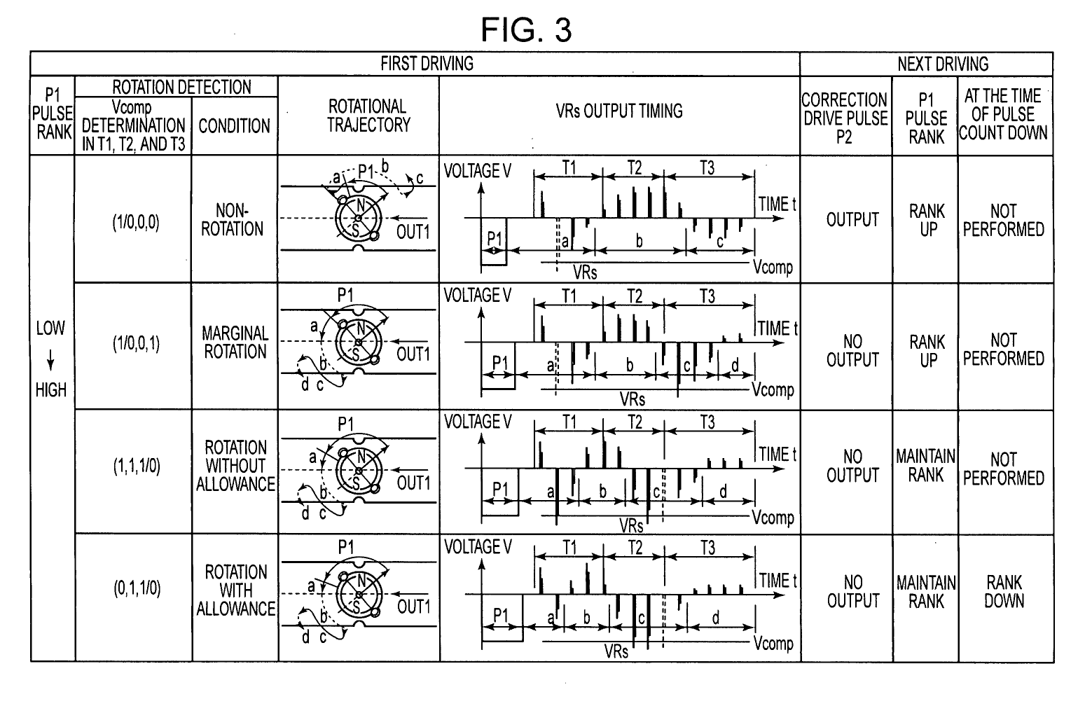

FIG. 3 is a timing chart in a case where the stepping motor 102 is driven by the main drive pulses P1 in this embodiment. It also shows a VRs pattern indicating the rotation condition, the rotation position of the rotor 202, and a pulse control operation as to whether the pulse rank of the main drive pulse P1 is changed, whether the driving by the correction drive pulse P2 is performed, and whether pulse down is performed when the driving is continued a predetermined number of times.

Referring to FIG. 3, P1 indicates the main drive pulse P1 and also indicates a section in which the rotor 202 is rotary driven by the main drive pulse P1. Lower-case letters a through d represent regions indicating the rotation position of the rotor 202 by free oscillations after the driving by the main drive pulse P1 is stopped.

A predetermined time immediately after the driving by the main drive pulse P1 is referred to as a first section T1, a predetermined time following the first section T1 is referred to as a second section T2, and a predetermined time following the second section T2 is referred to as a third section T3. In this manner, the entire detection period T that starts immediately after the driving by the main pulse P1 is divided to a plurality of sections (herein, three sections T1 through T3).

Because a time from the end of the driving by the main drive pulse P1 to the start of the detection period T is set to a certain time, it is configured in such a manner that in the case of main drive pulses other than the main drive pulse P1nmax in the highest pulse rank, a blank time is generated between the main drive pulse P1 and the first section T1, whereas in the case of the main drive pulse P1nmax in the highest pulse rank, the main drive pulse P1 and the first section T1 become continuous.

In a case where the X-Y coordinate space in which the main magnetic pole A of the rotor 202 is positioned due to its rotation is divided to the first through forth quadrants about the rotor 202, the first section T1 through the third section T3 can be described as follows. That is, the first section T1 is a section in which to determine rotations of the rotor 202 in the positive direction (region a) in the second quadrant, and the second section T2 and the third section T3 are sections in which to determine rotations of the rotor 202 in the inverse direction (region c) in the third quadrant.

The reference threshold voltage Vcomp is a reference threshold voltage in reference to which the voltage level of the induced signal VRs generated in the stepping motor 102 is determined in order to determine the rotation condition of the stepping motor 102. The reference threshold voltage Vcomp is set in such a manner that the induced signal VRs exceeds the reference threshold voltage Vcomp in a case where the rotor 202 performs a constant fast operation like in a case where the stepping motor 102 rotates, whereas the induced signal VRs does not exceed the reference threshold voltage Vcomp in a case where the rotor 202 does not perform a constant fast operation like in a case where the stepping motor 102 does not rotate.

Regarding the induced signal VRs generated by rotary free oscillations of the stepping motor 102, for example, in the case of a normal load (a load driven during normal times and, herein, a load when the time hands (hour hand, minute hand, and second hand) to display a time are driven), the rotation angle of the rotor 202 after the main drive pulse P1 is cut off overpasses the second quadrant. Hence, the induced signal VRs exceeding the reference threshold voltage Vcomp for rotation detection does not appear in the first section T1 and appears in and after the second section T2. In a case where there is a rotation allowance, the induced signal VRs appears in the second section T2 because the rotor 202 rotates fast and in a case where there is no rotation allowance, it appears in the third section T3 because the rotor 202 rotates slow.

In a case where the rotary driving of the rotor 202 no longer has an allowance, the rotor rotation oscillations after the main drive pulse P1 is cut off appear in a region (region a) of the second quadrant and the induced signal VRs appears in the first section T1. This indicates a state where a rotation allowance has been decreasing.

In light of the characteristics as above, the pulse control is performed in such a manner that the drive control is performed using a suitable drive pulse by precisely determining an allowance in drive energy.

For example, in a condition of rotation with an allowance of FIG. 3, the induced signal VRs generated in the region a occurs in the first section T1, and the induced signal VRs generated in the region c occurs in the second section T2 and the third section T3. It should be noted that the induced signal VRs generated in the regions b and d occurs over the first section T1 and the second section T2. This induced signal VRs, however, is not detected because it occurs in the polarity opposite to that of the reference threshold voltage Vcomp.

The pattern of the induced signal VRs (VRs pattern) is indicated by a combination of determination values as to whether the induced signal VRs exceeds the reference threshold voltage Vcomp in the respective sections T1 through T3, and it is indicated as (the determination value in the first section T1, the determination value in the second terminal T2, and the determination value in the third terminal T3). A case where the induced signal VRs exceeds the reference threshold voltage Vcomp is indicated by a determination value, “1”. A case where the induced signal VRs does not exceed the reference threshold voltage Vcomp is indicated by a determination value, “0”. A case where the determination value can take either “1” or “0” is indicated by “1/0”.

Referring to FIG. 3, for example, in a case where the VRs pattern as the result of driving by the main drive pulse P1 is (0, 1, 1/0), the control circuit 106 determines that the rotation condition is a rotation with an allowance in drive energy (rotation with allowance) and neither drives the stepping motor 102 by the correction drive pulse P2 nor changes the rank of the main drive pulse P1 but maintains the rank. It should be noted, however, that in a case where the pattern, (0, 1, 1/0), occurs successively a predetermined number of times (PCD), the control circuit 106 determines that there is an allowance in drive energy and downgrades the main drive pulse P1 by one rank (pulse down).

In a case where the VRs pattern is (1, 1, 1/0), the control circuit 106 determines that the rotation condition is a rotation without an allowance in drive energy (rotations without allowance) and performs pulse control not to change the main drive pulse P1 and thereby to maintain the rank without driving the stepping motor 102 by the correction drive pulse P2.

In a case where the VRs pattern is (1/0, 0, 1), the control circuit 106 determines that the rotation condition is a rotation with absolutely no allowance in drive energy (marginal rotations) and upgrades the main pulse P1 by one rank (pulse up) sufficiently ahead of time without driving the stepping motor 102 by the correction drive pulse P2 to avoid the stepping motor 102 from not rotating during the next driving.

In a case where the VRs pattern is (1/0, 0, 0), the control circuit 106 determines that the stepping motor 102 is not rotating (non-rotation) and upgrades the main drive pulse P1 by one rank after the stepping motor 102 is driven by the correction drive pulse P2.

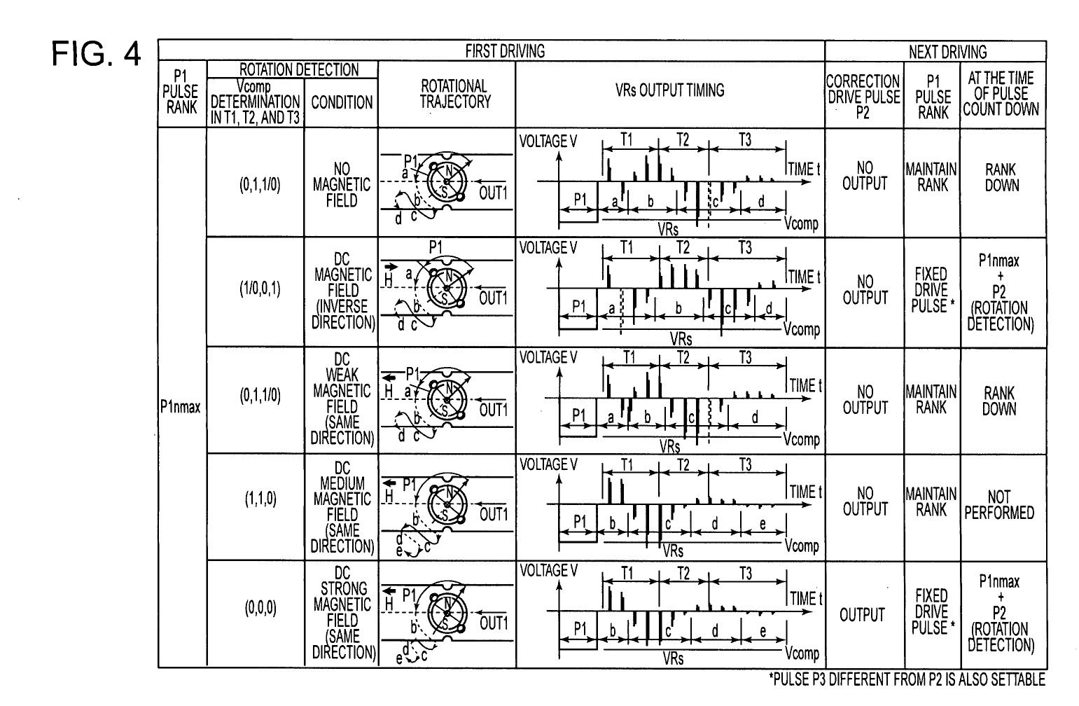

FIG. 4 is a timing chart used to describe influences of a DC magnetic field H during the driving by the main drive pulse P1nmax having the maximum drive energy in this embodiment. It also shows the VRs pattern indicating a rotation condition and a rotation state of the rotor 202 as well as the pulse control operation as to whether the stepping motor 102 is driven by the correction drive pulse P2, whether the rank of the main drive pulse is maintained, and whether pulse down is performed when the driving has continued a predetermined number of times (PCD).

When driven by the main drive pulse P1nmax, in a case where there is no allowance in drive energy, the stepping motor 102 is driven by switching to the fixed drive pulse having drive energy not smaller than that of the main drive pulse P1nmax. In the case of FIG. 4, however, the correction drive pulse P2 is used as the fixed drive pulse so as not to increase the types of drive pulse. Power can be saved by using the fixed drive pulse having drive energy smaller than that of the correction drive pulse P2.

FIG. 4 shows, sequentially from top to bottom, (1) a case where the rotor 202 is rotating with an allowance in drive energy in the absence of a DC magnetic field H, (2) a case where the rotor 202 is rotating without an allowance in drive energy in the presence of a DC magnetic field H in the inverse direction to the drive magnetic field, (3) a case where the rotor 202 is rotating with an allowance in drive energy in the presence of a DC weak magnetic field H in the same direction as the drive magnetic field, (4) a case where the rotor 202 is rotating with an allowance in drive energy in the presence of a DC medium magnetic field H stronger than that of (3) in the same direction as the drive magnetic field, and (5) a case where the rotor 202 is rotating in the presence of a DC strong magnetic field H stronger than that of (4) in the same direction as the drive magnetic field but an induced signal VRs exceeding the reference threshold voltage Vcomp is not detected (when there is a sign of decline) because damping by the DC magnetic field H is large.

As is shown in FIG. 4, a DC magnetic field H gives influences to decline the induced signal VRs or shift the occurrence time thereof. For example, in a case where the direction of a DC magnetic field H is the same as the direction of the magnetic field generated at the stator 201 by the driving, positional shifting takes place so that the induced signal VRs occurs earlier than in a case where a DC magnetic field is absent. In a case where the direction of a DC magnetic field H is inverse to the direction of the magnetic field generated at the stator 201 by the driving, positional shifting takes place so that the induced signal VRs occurs later than in a case where a DC magnetic field is absent.

In a case where the VRs pattern when driving the stepping motor 102 by the main drive pulse P1nmax is other than (1/0, 1, 1/0) (for example, in a case where “0” in the second section T2 and “1” in the third section T3), the control circuit 106 determines that there is no drive allowance even by the main drive pulse P1nmax because of influences of the DC magnetic field H and there is a risk that it becomes impossible to rotary drive the stepping motor 102 normally. Hence, the control circuit 106 drives the stepping motor 102 by making a change to a drive pulse (fixed drive pulse) having constant drive energy not smaller than that of the main drive pulse P1nmax. The fixed drive pulse only has to be a drive pulse having constant drive energy not smaller than that of the main drive pulse P1nmax, and as has been described above, the correction drive pulse P2 is used as the fixed drive pulse in this embodiment.

After the stepping motor 102 is driven the predetermined number of times, PCD, by the fixed drive pulse, the stepping motor 102 is driven by switching to the main drive pulse P1nmax in a case where driving with an allowance is possible by the main drive pulse P1nmax.

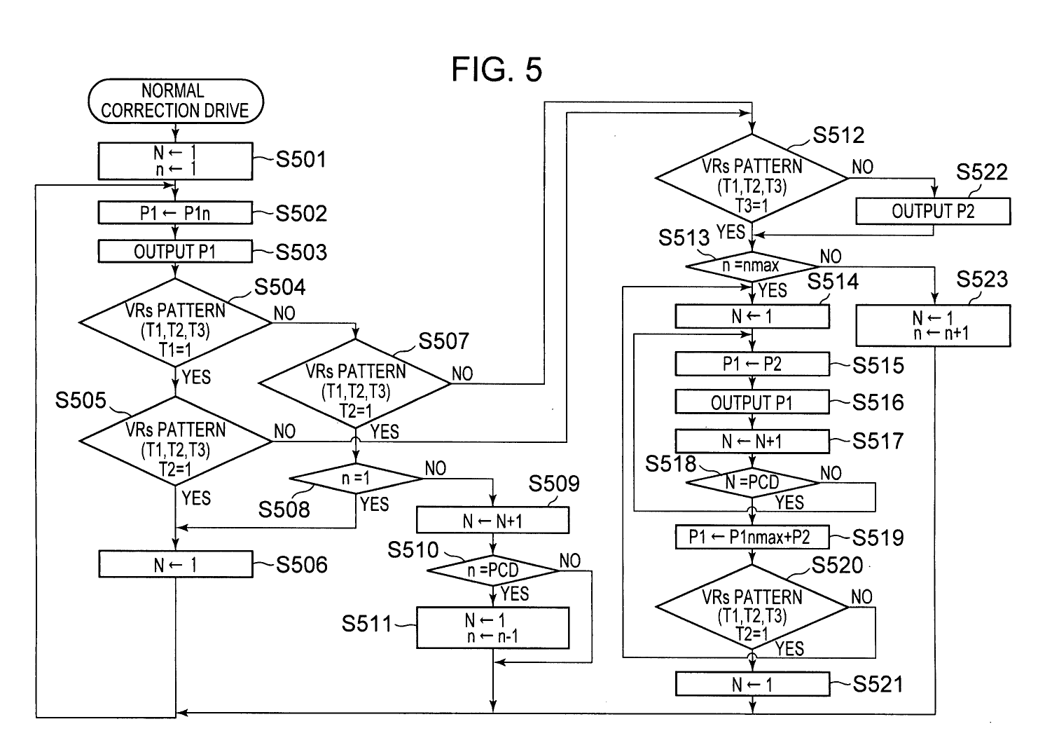

FIG. 5 is a flowchart depicting operations of the stepping motor control circuit and the analog electronic timepiece according to a first embodiment of the invention and it chiefly shows the processing in a case where the DC magnetic field H as shown in FIG. 4 is present.

Meanings of the respective symbols in FIG. 5 are as follows. That is, P1 indicates a main drive pulse that drives the stepping motor 102 during a normal drive operation (during normal correction drive).

The main drive pulse P1 for normal correction drive is a main drive pulse selected from the main drive pulses P1 by drive pulse selection processing described below. A lower-case letter n indicates the pulse rank of a main drive pulse P1 during normal correction drive and it includes a plurality of types from a rank 1 with the minimum drive energy to a rank nmax with the maximum drive energy.

P2 indicates a correction drive pulse during normal drive and it has drive energy not smaller than that of the main drive pulse P1nmax having the maximum energy preliminarily provided to the stepping motor control circuit. In this embodiment, the correction drive pulse P2 is used also as the fixed drive pulse.

Information on the main drive pulse P1, the correction drive pulse P2, and the fixed drive pulse is stored in the storage circuit 108.

A capital N indicates the number of repetition times of the driving by the same drive pulse and it takes a value ranging from 1 as the minimum value to the predetermined value (PCD).

Hereinafter, operations of the stepping motor control circuit and the analog electronic timepiece according to the first embodiment of the invention will be described in detail with reference to FIG. 1 through FIG. 5.

The oscillation circuit 104 generates the reference clock signal at a predetermined frequency and the frequency dividing circuit 105 frequency-divides the signal generated in the oscillation circuit 104 and outputs a timepiece signal as the timekeeping reference to the control circuit 106.

The control circuit 106 performs a timekeeping operation by counting the time signal and, in order to perform the pulse selection processing from the main drive pulses P1 in ascending order of the pulse ranks, it initially sets the rank n of the main drive pulse P1 first to the minimum rank, “1”, and the number of repetition times, N, of the drive pulse to 1 (Step S501). The control circuit 106 then outputs a control signal so that the stepping motor 102 is rotary driven by a main drive pulse P11 having the minimum pulse width (Steps S502 and S503).

The stepping motor drive pulse circuit 107 rotary drives the stepping motor 102 by the main drive pulse P11 in response to the control signal from the control circuit 106. The stepping motor 102 is thus rotary driven by the main drive pulse P11 and rotary drives the unillustrated time hands and the like. Accordingly, when the stepping motor 102 rotates normally, the current time is displayed by the time hands.

The rotation detection circuit 109 outputs a detection signal to the detection time comparison and determination circuit 110 each time it detects an induced signal VRs of the stepping motor 102 exceeding the reference threshold voltage Vcomp. The detection time comparison and determination circuit 110 determines the sections T1 through T3 in which the induced signal VRs exceeding the reference threshold voltage Vcomp is detected according to the detection signal from the rotation detection circuit 109 and notifies the control circuit 106 of the determination values, “1” or “0”, in the respective sections T1 through T3.

The control circuit 106 determines the VRs pattern, (the determination value in the first section T1, the determination value in the second section T2, and the determination value in the third section T3), indicating the rotation condition according to the determination values from the detection time comparison and determination circuit 110.

In a case where the determination values in the first section T1 and the second section T2 of the VRs pattern are “1” as the result of the driving by the main drive pulse P11, that is, in a case where the VRs pattern is (1, 1, 1/0) (Steps S504 and S505), the control circuit 106 determines that the rotation condition is rotations without an allowance. Hence, it maintains the rank of the main drive pulse P1 without any change and sets the number of repetition times, N, to 1, after which the control circuit 106 returns to Processing Step S502 (Step S506).

In a case where the control circuit 106 determines in Processing Step S505 that the induced signal VRs in the second section T2 does not exceed the reference threshold value Vcomp (in a case where the determination values in the sections T1 and T2 are (1, 0)), the control circuit 106 proceeds to Processing Step S512.

In a case where the control circuit 106 determines in Processing Step S504 that the determination value in the first step T1 is “0” and also determines in Processing Step S507 that the determination value in the second section T2 is “1”, that is, in a case where there is a drive allowance, the control circuit 106 proceeds to Processing Step S506 when the pulse rank n is “1” (Steps S507 and S508).

In a case where the pulse rank n is not “1” in Processing Step S508, the control circuit 106 adds “1” to the number of repetition times, N (Step S509). When the number of repetition times, N, reaches the predetermined number of times (PCD), it sets the number of repetition times, N, to 1 and downgrades the pulse rank n by one rank, after which it returns to Processing Step S502 (Steps S510 and S511). When the number of repetition times, N, has not reached the predetermined number of times, PCD, in Processing Step S510, the control circuit 106 immediately returns to Processing Step S502.

In a case where the determination value in the second section T2 in Processing Step S507 is “0”, the control circuit 106 proceeds to Processing Step S512.

In a case where the determination value in the third section T3 in Processing Step S512 is “1”, that is, in a case where it is determined that there is no drive allowance in drive energy, the control circuit 106 determines whether the pulse rank n of the main drive pulse P1 takes the maximum value nmax (Step S513).

Processing Step S513 is the processing to determine whether the main drive pulse P1 is P1nmax in the highest pulse rank, so that when the main drive pulse P1 is P1nmax in the highest pulse rank, the stepping motor 102 is driven by the correction drive pulse P2 as the fixed drive pulse and when the number of repetition times, N, is the predetermined number of times, PCD, it is determined whether the rank of the main drive pulse P1 is controlled variably or the stepping motor 102 is driven by the fixed drive pulse according to the determination by the VRs pattern.

When the control circuit 106 determines in Processing Step S513 that the main drive pulse P1 is P1nmax in the highest pulse rank, it resets the number of repetition times, N, to “1” (Step S514) and selects the correction drive pulse P2 as the fixed drive pulse (Step S515) to drive the stepping motor 102 by the fixed drive pulse (Step S516).

Subsequently, the control circuit 106 adds “1” to the number of repetition times, N (Step S517) to determine whether the number of repetition times, N, has reached the predetermined number of times, PCD (Step S518).

When the control circuit 106 determines in Processing Step S518 that the number of repetition times, N, has reached the predetermined number of times, PCD, it determines whether the driving by the fixed drive pulse is continued or it shifts to a pulse control operation by which the pulse rank of the main drive pulse is changed. More specifically, in a case where the control circuit 106 determines in Processing Step S518 that the number of repetition times, N, has reached the predetermined number of times, PCD, in order to check whether there is a drive allowance, it drives the stepping motor 102 by the correction drive pulse P2 as the fixed drive pulse after the stepping motor 102 is driven by the main pulse drive P1nmax having the maximum energy instead of the fixed drive pulse in case the stepping motor 102 cannot be rotated by the main drive pulse P1nmax (Step S519).

The control circuit 106 determines the rotation condition during the driving by the main drive pulse P1nmax in Processing Step S519. When it determines that the determination value in the second section T2 in the VRs pattern is “1” (Step S520), it determines that there is an allowance in drive energy and it can shift to the pulse control operation. Hence, it returns to Processing Step S502 after it resets the number of repetition times, N, to 1 to start the driving by the main drive pulse P1nmax (Step S521). When the control circuit 106 determines in Processing Step S520 that the determination value in the second section T2 is not “1”, it determines that the stepping motor 102 needs to be driven by the fixed drive pulse and returns to Processing Step S514.

When the control circuit 106 determines in Processing Step S518 that the number of repetition times, N, has not reached the predetermined number of times, PCD, it returns to Processing Step S515. When the control circuit 106 determines in Processing Step S513 that the main drive pulse P1 is not P1nmax in the highest pulse rank, it resets the number of repetition times, N, to “1” and upgrades the pulse rank by one rank, after which it returns to Step S502 (Step S523). Also, in a case where the determination value in the third section T3 in Processing Step S512 is “0”, the control circuit 106 drives the stepping motor 102 by the correction drive pulse P2 to forcedly rotate the stepping motor 102, after which it proceeds to Processing Step S513 (Step S522).

As has been described, according to the first embodiment, the stepping motor control circuit includes the rotation detection portion that detects a rotation condition of the stepping motor 102 and the control portion that drives and controls the stepping motor by any one of a plurality of main drive pulses P1 each having different drive energy or a drive pulse having drive energy not smaller than drive energies of the main drive pulses P1 depending on a detection result of the rotation detection portion. In a case where there is no drive allowance when the stepping motor 102 is driven by the main drive pulse P1nmax having the maximum drive energy, the control portion drives the stepping motor by switching to the fixed drive pulse having drive energy not smaller than that of the main drive pulse P1nmax having the maximum drive energy.

Hence, in a case where the second section T2 does not take “1” due to influences of a DC magnetic field H, it is determined that there is no allowance even by the main drive pulse P1nmax and the stepping motor is driven by the fixed drive pulse having larger energy, so that stable driving is enabled even in the presence of the DC magnetic field H.

In a case where the stable driving is performed a predetermined number of times by the fixed drive pulse, it becomes possible to stabilize the drive operation and reduce power consumption by starting the pulse control operation by downgrading the rank of drive pulse from the fixed drive pulse to the main drive pulse P1nmax when driving with an allowance is possible by the main drive pulse P1nmax.

In addition, there is no need to provide a complex detection circuit and the configuration becomes simpler.

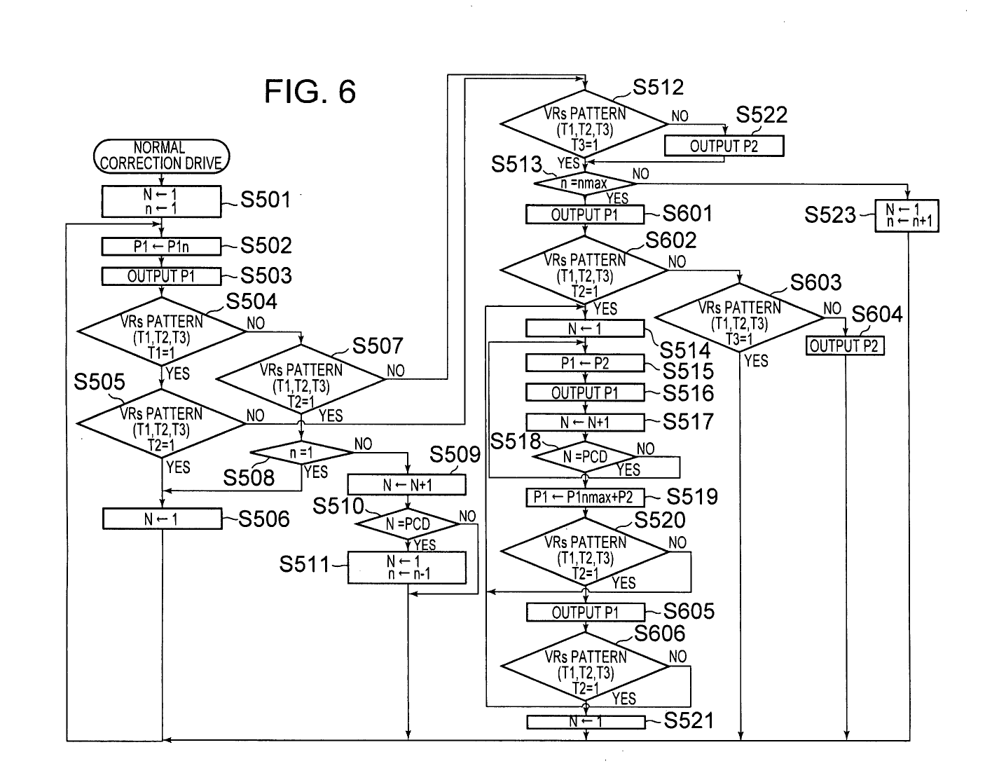

FIG. 6 is a flowchart depicting operations of a stepping motor control circuit and an analog electronic timepiece according to a second embodiment of the invention. Like steps in which the same processing with respect to FIG. 5 is performed are labeled with like reference numerals.

In the second embodiment, by taking the drive result in the both polarities into account, switching driving to the fixed drive pulse and switching driving from the fixed drive pulse to the main drive pulse P1nmax or the like are controlled. The block diagram and the configuration of the stepping motor used herein are the same as those in FIG. 1 and FIG. 2.

Hereinafter, operations of the second embodiment will be described for a portion different from the first embodiment above.

The control circuit 106 drives the stepping motor 102 by the main drive pulse P1nmax in one polarity (Step S503) and determines whether the determination value in the third section T3 is “1” (Step S512). Then, when it determines that the pulse rank n of the main drive pulse P1 is the maximum value nmax (Step S513), it drives the stepping motor 102 by the main drive pulse P1nmax in the other polarity (Step S601).

In a case where the second section T2 takes “1” in the VRs pattern, the control circuit 106 performs processing in and after Processing Step S514.

In this manner, in a case where the second section T2 takes “0” and the third section T3 takes “1” when the stepping motor 102 is driven by the main drive pulse P1nmax in one polarity (Steps S507 and S512) and the second step T2 takes “1” when the stepping motor 102 is driven by the main drive pulse P1nmax in the other polarity (Step S602), it is determined that a DC magnetic field H is present and the stepping motor 102 is driven by switching the main drive pulse P1nmax to the correction drive pulse P2 as the fixed drive pulse (Step S515).

In a case where the control circuit 106 determines in Processing Step S520 that the determination value in the second section T2 during the driving by the main drive pulse P1nmax in one polarity is “1” and the determination value in the second section T2 during the driving by the main drive pulse P1nmax in the other polarity (Step S605) is “1” (Step S606), it determines that it can shift to the pulse control operation because there is an allowance in drive energy. Hence, it resets the number of repetition times, N, to 1, after which it returns to Processing Step S502 to start driving the stepping motor 102 by the main drive pulse P1nmax (Step S521).

In a case where the control circuit 106 determines in Processing Step S606 that the determination value in the second section T2 is “0”, it returns to Processing Step S514.

In a case where the second section T2 takes “0” in Processing Step S602, the control circuit 106 determines whether the third section T3 in the VRs pattern takes “1” (Step S603). In a case where the third section T3 takes “1” in Processing Step S603, the control circuit 106 returns to Processing Step S502, whereas in a case where the third section T3 takes “0”, it drive the stepping motor 102 by the correction drive pulse P2 to forcedly rotary drive the stepping motor 102 and returns to Processing Step S502 (Step S604).

According to the second embodiment, advantages same as those of the first embodiment above can be achieved. Moreover, it is configured in such a manner that the presence of a DC magnetic field H is determined according to the driving result by the main drive pulse P1nmax in the both polarities and the presence of the DC magnetic field H is determined when the second section T2 does not take “1” in at least one of the polarities and the stepping motor 102 is driven by switching the main drive pulses P1nmax to the fixed drive pulse. Alternatively, in a case where rotation allowances during the driving in the both polarities are different, the presence of the DC magnetic field H is determined and the stepping motor 102 is driven by switching the main drive pulse P1nmax to the fixed drive pulse.

In this manner, in a case where it is determined that there are influences of the DC magnetic field. H, it is determined that there is no allowance even by the main drive pulse P1nmax and the stepping motor is driven by the fixed drive pulse having larger energy, so that stable driving is enabled even in the presence of the DC magnetic field H.

Also, according to the analog electronic timepieces of the respective embodiments, a precise hand movement operation is enabled even in the presence of the DC magnetic field H.

The respective embodiments are configured in such a manner that rectangular waves have different pulse widths in order to change energies of the respective main drive pulses. It should be appreciated, however, that driving energy can be changed by changing an ON/OFF duty by making the pulse itself in a comb shape or by changing a pulse voltage.

While the electronic timepiece has been described as an example of an application of the stepping motor, it should be appreciated that the invention is also applicable to an electronic device using a motor.

The stepping motor control circuit of the invention is applicable to various electronic devices using a stepping motor.

Also, the electronic timepiece of the invention is applicable to various analog electronic timepieces, such as an analog electronic timepiece with a calendar function and a chronograph timepiece.

What is claimed is:

1. A stepping motor control circuit, comprising:
a rotation detection portion that detects a rotation condition of a stepping motor; and
a control portion that drives and controls the stepping motor by a correction drive pulse having larger drive energy than one of any one of a plurality of main drive pulses each having different drive energy and the respective main drive pulses depending on a detection result of the rotation detection portion,
wherein the control portion drives the stepping motor by switching to a fixed drive pulse having drive energy not smaller than drive energy of a main drive pulse having maximum drive energy in a case where there is no drive allowance when the stepping motor is driven by the main drive pulse having the maximum drive energy.

2. A stepping motor control circuit according to claim 1, wherein:
the rotation detection portion detects an induced signal generated by a rotation of a rotor of the stepping motor and detects the rotation condition of the stepping motor depending on whether the induced signal exceeds a predetermined reference threshold voltage within a predetermined detection period;
the detection period is divided to a first section immediately after the stepping motor is driven by the main drive pulse, a second section later than the first section, and a third section later than the second section while the first section is a section in which a rotation in a positive direction of the rotor in a second quadrant about the rotor is determined and the second section and the third section are sections in which a rotation in an inverse direction of the rotor in a third quadrant is determined; and
the control portion determines that there is no drive allowance in a case where the rotation detection portion does not detect an induced signal exceeding the reference threshold voltage in the second section when the stepping motor is driven by the main drive pulse having the maximum drive energy and drives the stepping motor by switching to the fixed drive pulse.

3. A stepping motor control circuit according to claim 1, wherein:
the control portion drives the stepping motor by switching to the fixed drive pulse in a case where there is no drive allowance in one polarity when the stepping motor is driven by the main drive pulse having the maximum drive energy alternately in different polarities.

4. A stepping motor control circuit according to claim 2, wherein:
the control portion drives the stepping motor by switching to the fixed drive pulse in a case where there is no drive allowance in one polarity when the stepping motor is driven by the main drive pulse having the maximum drive energy alternately in different polarities.

5. A stepping motor control circuit according to claim 3, wherein:
the control portion drives the stepping motor by switching to the fixed drive pulse in a case where the rotation detection portion detects an induced signal exceeding the reference threshold voltage in the second section in one polarity and in the third section in the other polarity when the stepping motor is driven by the main drive pulse having the maximum drive energy alternately in different polarities.

6. A stepping motor control circuit according to claim 4, wherein:
the control portion drives the stepping motor by switching to the fixed drive pulse in a case where the rotation detection portion detects an induced signal exceeding the reference threshold voltage in the second section in one polarity and in the third section in the other polarity when the stepping motor is driven by the main drive pulse having the maximum drive energy alternately in different polarities.

7. A stepping motor control circuit according to claim 1, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

8. A stepping motor control circuit according to claim 2, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

9. A stepping motor control circuit according to claim 3, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

10. A stepping motor control circuit according to claim 4, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

11. A stepping motor control circuit according to claim 5, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

12. A stepping motor control circuit according to claim 6, wherein:
after the stepping motor is driven continuously a predetermined number of times by the fixed drive pulse, when there is a rotation allowance as a result of rotary driving the stepping motor by the main drive pulse having the maximum drive energy, the control portion drives the stepping motor by switching to the main drive pulse having the maximum drive energy from the fixed drive pulse.

13. A stepping motor control circuit according to claim 1, wherein:
the fixed drive pulse is the correction drive pulse.

14. A stepping motor control circuit according to claim 2, wherein:
the fixed drive pulse is the correction drive pulse.

15. A stepping motor control circuit according to claim 3, wherein:
the fixed drive pulse is the correction drive pulse.

16. A stepping motor control circuit according to claim 4, wherein:
the fixed drive pulse is the correction drive pulse.

17. A stepping motor control circuit according to claim 5, wherein:
the fixed drive pulse is the correction drive pulse.

18. A stepping motor control circuit according to claim 6, wherein:
the fixed drive pulse is the correction drive pulse.

19. A stepping motor control circuit according to claim 7, wherein:
the fixed drive pulse is the correction drive pulse.

20. An analog electronic timepiece, comprising:
a stepping motor that rotary drives an hour hand; and
a stepping motor control circuit that controls the stepping motor,
wherein the stepping motor control circuit set forth in claim 1 is used as the stepping motor control circuit.
